(19) United States
(12) Patent Application Publication
(10) Pub. No.: US 2026/0057221 A1
(43) Pub. Date: Feb. 26, 2026

(54) GENERATIVE ARTIFICIAL INTELLIGENCE ASSISTANCE IN CLOUD COMMAND LINE INTERFACE

(71) Applicant: ORACLE INTERNATIONAL CORPORATION, Redwood Shores, CA (US)

(72) Inventor: Badr Mohamed Tharwat MOHAMED, Riyadh - KSA (SA)

(21) Appl. No.: 18/814,747

(22) Filed: Aug. 26, 2024

(51) Int. Cl. G06N 3/0475

(52) U.S. Cl. CPC G06N 3/0475

(57) ABSTRACT

Systems, methods, and other embodiments associated with generative AI assistance that is integrated into a command line interface (CLI) to a cloud platform are described. In one embodiment, an example method includes intercepting, in a command line interface to a cloud platform, a command to the cloud platform. The example method recording the command in a conversation history and passing the command to the cloud platform to execute. The example method includes intercepting a response to the command that was returned from the cloud platform to the command line interface. The example method includes recording the response in the conversation history and passing the response to a large language model (LLM) to initiate generation of an enhanced response in context of the conversation history. The example method includes receiving the enhanced response from the LLM. And, the example method includes presenting the enhanced response in the command line interface.

### BACKGROUND

Command line interfaces to cloud infrastructure can be complex, and may confuse users with obscure output and error messages that are hard to explain. The CLI output can be cryptic and challenging to interpret, hindering efficient troubleshooting and usage for both new and experienced users. Even the most user-friendly CLI still requires significant knowledge and ability to translate error messages on the part of the user. Also, existing CLIs lack the ability to make suggestions in view of the tasks being attempted by the CLI user.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a CLI assistance system that is associated with integration of generative AI assistance into a cloud CLI.

FIG. 2 illustrates one embodiment of a CLI assistance method that is associated with integration of generative AI assistance into a cloud CLI.

FIG. 3 illustrates one embodiment of a CLI assistance data flow that is associated with integration of generative AI assistance into a cloud CLI.

FIG. 4 illustrates an embodiment of a computing system configured with the example systems and/or methods disclosed.

### DETAILED DESCRIPTION

Systems, methods, and other embodiments are described herein that provide for a generative AI assistance that is integrated into a command line interface (CLI) to a cloud platform. In one embodiment, a CLI assistance system is configured to capture user inputs and system outputs of a CLI interface, and provide context-aware, human-language narrative in line in the CLI interface. The narrative may interpret CLI error messages and offer actionable recommendations and guidance, add explanatory notes to CLI output, disambiguate technical jargon presented in the CLI, summarize technical output of the CLI, or otherwise enhance interactions through the CLI.

In one embodiment, the CLI assistance system improves over existing cloud CLI technology by providing generative AI assistance that is aware of the context of the CLI session. In one embodiment, the CLI assistance system improves over existing cloud CLI technology by capturing a history of command line interactions for a session to maintain the context of the session. In one embodiment, the CLI assistance system improves over existing cloud CLI technology by embedding this session-context-aware generative AI assistance natively in the cloud CLI, allowing the assistance to be automatically offered in-line in the cloud CLI in response to the user's interactions with the cloud platform. In one embodiment, the CLI assistance system improves over existing cloud CLI technology by understanding, from the context, a multi-command task that a user is attempting to complete, allowing the CLI assistance system to suggest additional steps to complete the task. In one embodiment, the context-awareness of the CLI assistance system is a substantial improvement beyond generative AI responses that passively respond to cloud platform responses to commands without considering context. In one embodiment, the CLI assistance system improves over existing cloud CLI technology by bridging the gap between technical command structures and user-friendly explanations, improving overall efficiency and reducing errors. The CLI assistance system thus improves over existing cloud CLI technology, making it easier for users to deploy, configure, and troubleshoot cloud services in the command line.

In one embodiment, the CLI assistance system improves over existing generative AI technology by integrating context-aware generative AI directly into the command line interface of a cloud. In one embodiment, CLI assistance system improves over existing workflow automation technology by identifying what task a user is attempting to accomplish from the context of the user's activities, and producing guidance that is appropriate to the user's progress through the task.

In one embodiment, as a high-level overview, a CLI assistance system intercepts content of a CLI to a cloud platform. The content may be, for example, user-entered commands, cloud-platform-generated error responses or confirmation responses, or even in-line conversational prompts to an LLM-based CLI assistant. The CLI assistance system appends the intercepted content to a conversation history so as to maintain context of the CLI session. The CLI assistance system generates enhanced CLI content in view of the conversation history (for context-awareness of the CLI session as a whole). The enhanced CLI content may be, for example, suggestions to correct a malformed or incomplete command, an explanation of an error response by the cloud platform and suggestions to correct the error, an explanation of a confirmation response by the cloud platform and suggestions for next steps in a process, and/or a conversational reply to a conversational prompt entered in-line in the CLI. The CLI assistance system transmits the enhanced CLI content to display in-line in the CLI to the cloud platform.

No action or function described or claimed herein is performed by the human mind. An interpretation that any action or function can be performed in the human mind is inconsistent with and contrary to this disclosure.

### —Example CLI Assistance System—

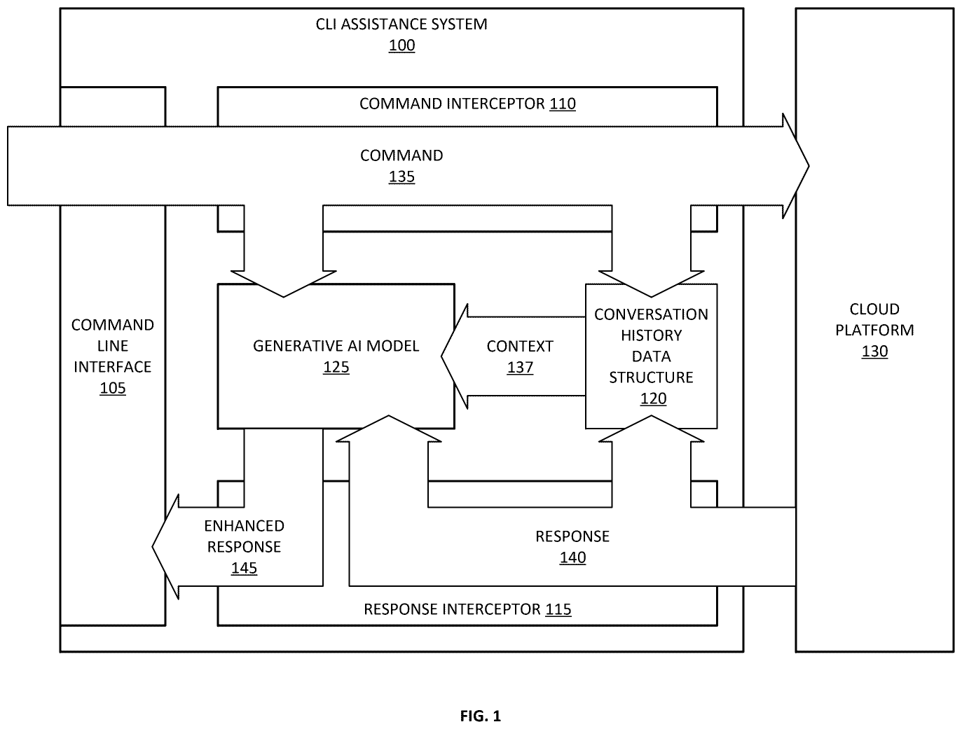

FIG. 1 illustrates one embodiment of a CLI assistance system 100 that is associated with integration of generative AI assistance into a CLI to a cloud platform. CLI assistance system 100 includes components that are configured to intercept or capture CLI commands to, and responses from, a cloud platform, and pass them to a generative AI model to produce enhanced responses for the CLI. In one embodiment, CLI assistance system 100 includes a command line interface 105, a command interceptor 110, a response interceptor 115, a conversation history data structure 120 and a generative AI model 125. CLI assistance system 100 enhances communications between command line interface 105 and a cloud platform 130. In one embodiment, the components of CLI assistance system 100 intercommunicate to provide data or results to one another, for example by electronic messages as discussed below under the heading “Cloud or Enterprise Embodiments”.

In one embodiment, command line interface 105 is configured to accept input of a command 135 to cloud platform 130. And, command line interface 105 is configured to present an enhanced response 145 to the command 135. Command line interface 105 is configured to provide users with a set of functions to manage and interact with resources of the cloud platform 130. The form of the command 135 associated with these functions may vary depending on the provider of the cloud platform 130.

In one embodiment, command line interface 105 is further configured to execute or interact with the command interceptor 110 and response interceptor 115. In one embodiment, to configure the command line interface 105, one or more terminal-based libraries of scripts for interacting with the generative AI model 125 is imported into the command line interface 105, and an API key for accessing the generative AI model 125 is loaded in the command line interface 105. A script for performing the functions of command interceptor 110 is loaded in the command line interface 105. And a script for performing the functions of response interceptor 115 is loaded in the command line interface 105. In one embodiment, the scripts are written in Python, Bash, or another scripting language suitable for intercepting and logging commands and responses. In one embodiment, command line interface 105 is configured with automation tools such as Oracle cloud scheduler, cron jobs, or systemd services to automate execution of the appropriate script upon receiving a command or response.

In one embodiment, command interceptor 110 is configured to (1) intercept, in a command line interface 105 to a cloud platform, a command 135 to the cloud platform 130; and then (2) record the command in a conversation history and also pass the command to the cloud platform to execute. In one embodiment, command interceptor 110 is a script or other module. In one embodiment, the command interceptor 110 is configured to be run automatically in response to command line interface 105 receiving the command 135.

In one embodiment, command interceptor 110 is configured to monitor and capture commands 135 to the cloud platform 130 as they are entered in the CLI 105. Command interceptor 110 is configured to forward, transmit, or otherwise permit passage of the command 135 to an API gateway (or other CLI back-end) of the cloud platform 130 to be executed as instructed. Command interceptor 110 is configured to additionally forward, transmit, or otherwise redirect the command 135 into conversation history data structure 120 to be added as context 137 for reference by the generative AI model 125. The generative AI model 125 thereby ensured to be aware of (or otherwise have access to) the recent command 135 in subsequent interactions.

In one embodiment, command interceptor 110 is also configured to pass the command 135 to a generative AI model 125 to obtain enhanced feedback regarding the command. For example, command interceptor 110 may be configured to dynamically generate a prompt to the generative AI model 125 that incorporates the command 135 as a payload. In one embodiment, command interceptor 110 may be further configured to intercept commands 135 that are incomplete commands (or otherwise malformed), and not pass them to cloud platform 130. Instead of permitting passage of the command 135 when it is incomplete, command interceptor 110 may be configured to pass the incomplete command to the generative AI model 125 in a dynamically generated prompt for handling the incomplete command.

For example, the prompt for handling the incomplete command instructs the generative AI model 125 to produce an enhanced response 145 that explains why the command 135 is incomplete and gives an example of command 135 that is a complete command. In one embodiment, command interceptor 110 may be configured with regular expressions that detect when commands 135 are incomplete (or malformed). In response to detection that a command 135 is incomplete, the command 135 is prevented from proceeding to the cloud platform 130, and is sent instead to generative AI model 125 for generation of corrective instructions regarding the incomplete command 135. The corrective instructions may be delivered as the enhanced response 145 into the command line interface 105.

In one embodiment, command interceptor 110 is also configured to detect when the command 135 is a request for assistance or information (or other prompt for conversing) directed to the generative AI model 125, rather than to the cloud platform. For example, command interceptor 110 may be configured to parse the command 135, and detect that the command 135 is a prompt to the generative AI model 125 based on the content of the command 135. Command interceptor 110 may be configured with regular expressions to make this detection. For example, the command 135 may be considered to be a prompt when prefaced by the term “assistant” or another term that directs the command 135 to the generative AI model, or when the prompt appears to be in a format indicative of human language rather than of a command to the cloud platform.

Therefore, in one embodiment, command interceptor 110 is further configured to intercept commands 135 that are prompts directed to the generative AI, and not pass them to cloud platform 130. In response to the command 135 being determined to be a prompt, command interceptor 110 is configured to prevent the command 135 from proceeding to the cloud platform 130, and instead to pass the prompt to the generative AI model 125 for generation of a response to the prompt. In one embodiment, the prompt entered by the user (command 135) is embedded in a dynamically generated prompt, which is in turn passed to the generative AI model 125. The dynamically generated prompt is configured to cause the generative AI model 125 to refer to the context of the conversation history when responding. For example, the command interceptor 110 may dynamically generates a prompt that states “Please respond to the following in view of the conversation so far: [command 135]”. The response to the prompt may be delivered as the enhanced response 145 into the command line interface 105.

In this way, the user is enabled to request, by text in the command line interface 105, that the CLI assistance system 110 provide advice. For example, when running commands, if the user were to become stuck and need help in the context of the history of the commands and conversation, the user may request and receive help in the command line interface 105 itself. For example the user may ask, in the command line interface 105, what is a best practice for a task at hand, or what does a particular component (such as a web application firewall) do under a given configuration.

In one embodiment, response interceptor 115 is configured to (1) intercept a response 140 to the command 130 that was returned from the cloud platform 130 to the command line interface 105; (2) record the response 140 in the conversation history data structure 120; (3) pass the response 140 to the generative AI model 125 to initiate generation of an enhanced response 145 based at least in part on the response 140 and context 137 from the conversation history data structure 120; and (4) receive the enhanced response 145 from the generative AI model 125. In one embodiment, response interceptor 115 is a script or other module. In one embodiment, response interceptor 115 is configured to be run automatically in response to command line interface 105 receiving a response 140 from the cloud platform 130.

Thus, in one embodiment, the response interceptor 115 is configured to monitor, capture, and log cloud platform 135 responses 140 as they are returned from the cloud platform 130. And, the response interceptor 115 is configured to trigger a generative AI model 125 to produce an enhanced reply 145 from the response 140 and context 137 from previous interactions for the session, as stored in conversation history data structure 120.

In one embodiment, response interceptor 115 is further configured to handle errors of generative AI model 125, such as model unavailability or context processing issues. For example, in the event of generative AI model 125 returning an error, the response interceptor 115 may be configured to forward, transmit, or otherwise permit passage of the response 140 from cloud platform 130 without modification (i.e., without conversion into an enhanced response 145), and possibly accompanied by a message stating that the CLI assistance system is currently unavailable.

In one embodiment, conversation history data structure 120 is configured to record commands 130 and responses 145. In one embodiment, conversation history data structure 120 is configured to accept and store commands 130 and responses 145 in an order of time stamps associated with the commands 130 and responses 145. In conversation history data structure 120, individual commands 130 and responses 145 may be labeled as either a command 130 or a response 145. In one embodiment, conversation history data structure 120 is a database system or file system that is configured for logging and conversation history management. In one embodiment, conversation history data structure 120 uses a structured file system for storing a log of the commands 130 and responses 140. In another embodiment, conversation history data structure 120 uses a database system such as SQL, SQLite, MySQL, or NoSQL databases like MongoDB to store and manage the history of commands 130 and responses 140. Portions or the entirety of the record of commands 130 and responses 140 stored in conversation history data structure 120 may be provided as context 137 to generative AI model 125.

In one embodiment, generative AI model 125 is configured to accept prompts from command interceptor 110 and response interceptor 115. For example, generative AI model 125 receives prompts from command interceptor 110 and response interceptor 115 through an API. The prompts include CLI 105 content, such as commands 130 and responses 140, accompanied by other instructions to the generative AI model 125. The prompts describe information to be generated by the generative AI model 125 based on the commands 130 and responses 140. In one embodiment, the generative AI model 125 is configured to manage context by keeping track of the sequence of commands 130 and responses 140. Such context tracking enables the generative AI model 125 to understand the progress of the user through a task, maintaining coherent and relevant assistance in enhanced responses 135.

In one embodiment, the generative AI model 125 is operated in the cloud platform 130. In one embodiment, the generative AI model 125 is operated as a service by a third-party provider.

In one embodiment, generative AI model 125 is a large language model (LLM). In one embodiment, the LLM is a Cohere LLM, or a ChatGPT LLM. In general, the LLM is based on transformers. Other LLMs may also be suitable, such as other GPT (Generative Pre-trained Transformer), BERT (Bidirectional Encoder Representations from Transformers), T5 (Text-To-Text Transfer Transformer), PaLM (Pathways Language Model), Claude, ROBERTa, GPT-Neo, GPT-J, GPT-NeoX, Jurassic-1 Jumbo, OPT (Open Pretrained Transformer), LLAMA (Large Language Model Meta AI), M6, PLUG (Pretrained Language model for Understanding and Generation), and Megatron-Turing NLG, as well as the non-transformer-based Watson Natural Language Understanding and Watson Assistant. In one embodiment, the generative AI model is not an LLM, but is instead a recurrent neural network (RNN), or long short-term memory (LSTM) network.

In one embodiment, the generative AI model 125 is fine-tuned or otherwise adapted to the task of responding to prompts containing CLI 105 commands 130 and responses 140. In one embodiment, the generative AI model 125 has been trained on a dataset that is curated to be specific to the domain of the CLI 105 to the cloud platform 130. For example, the generative AI model 125 may be trained using existing manuals for the cloud platform 130 and the CLI 105 to the cloud platform 130. Or, for example, the generative AI model may be trained using content from a software collaboration community (such as GitHub) that is specific to the cloud platform 130 and the CLI 105 to the cloud platform 130. In this way, the generative AI model is trained to have an explanatory style that effectively communicates technical concepts about the CLI and the cloud platform in a user-friendly way.

In one embodiment, cloud platform 130 is configured to deliver a suite of cloud computing services to build, deploy, and manage applications and services through a network of remote servers hosted on the internet. For example, cloud platform 130 may be configured to provide a variety of services, including computing power, storage, networking, databases, and other services, which can be accessed and managed over the web or through APls. In one embodiment, cloud platform 130 may be any of Oracle Cloud Infrastructure (OCI), Amazon Web Services (AWS), Google Cloud Platform (GCP), Microsoft Azure, IBM Cloud, SAP Cloud, VMware Cloud, DigitalOcean, Alibaba Cloud, Tencent Cloud, Huawei Cloud, or other cloud platforms that have command line interfaces.

In one embodiment, cloud platform 130 is configured to accept commands 135 received through CLI 105 and generate responses 140 for presentation in CLI 105. For example, the commands 135 may be received though an API of the cloud platform 130, and the responses 140 may be transmitted through the API. Cloud platform 130 is configured to, in response to receiving commands 135, process the received commands 130 by interacting with the underlying cloud services to perform the requested operations. For example, the CLI command 135 is parsed and authenticated, and then cloud platform 130 initiates the necessary actions, such as launching a virtual machine, creating a storage bucket, or retrieving information about existing resources. The cloud platform 130 then generates a response 140 based on the outcome of the command, which is sent back to the CLI. This response 140 typically includes information about the success of the operation (e.g., a confirmation message) or failure of the operation (e.g., an error message), along with any relevant data, such as instance IDs, status messages, or error codes.

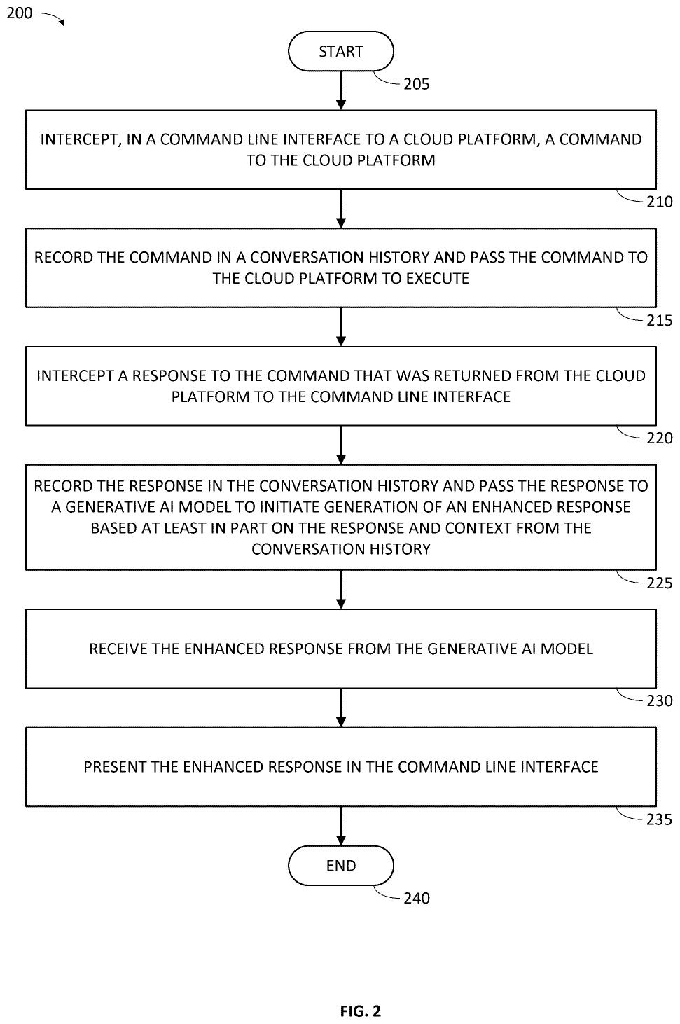

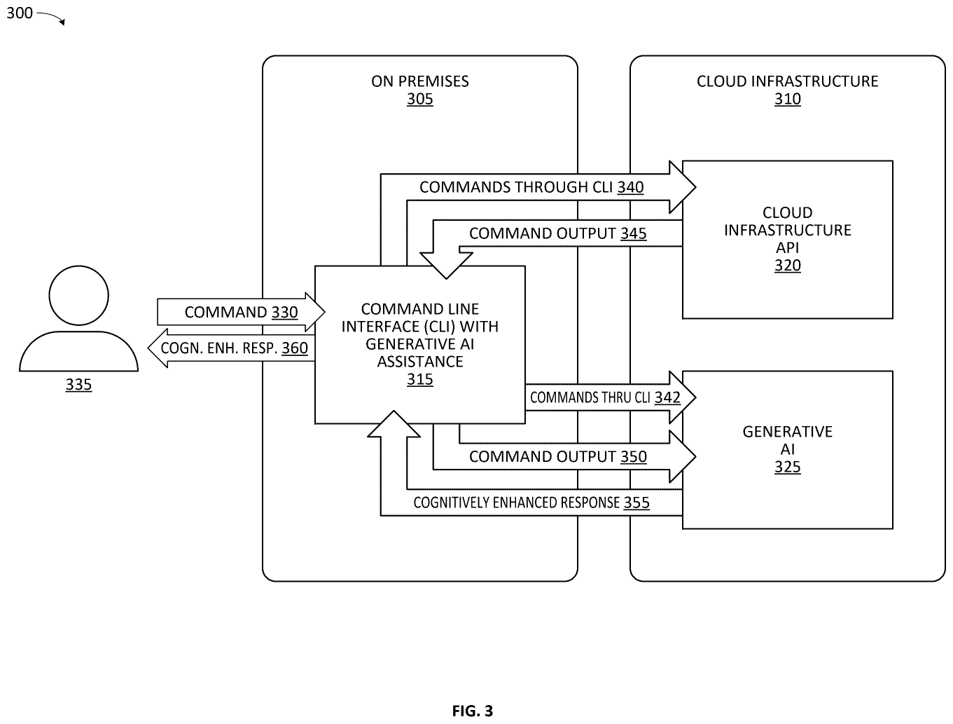

Further details regarding CLI assistance system 100 are presented herein. In one embodiment, operations of CLI assistance system 100 will be described with reference to example CLI assistance method 200 of FIG. 2 and CLI assistance data flow 300 of FIG. 3.

### —Example CLI Assistance Method—

FIG. 2 illustrates one embodiment of a CLI assistance method 200 that is associated with integration of generative AI assistance into a CLI to a cloud platform. CLI assistance method 200 is one example process for integrating generative AI assistance in-line in the cloud platform. In one embodiment, the generative AI assistance is delivered in real-time or near real-time. In one embodiment, the generative AI assistance adds context-aware explanations, feedback, and/or suggestions in response to CLI content.

In one embodiment, as a general overview, CLI assistance method 200 operates to record a conversation history of command line activity by a user, and use the record of the activity along with a current response by the cloud platform to generate an AI-enhanced response for presentation to the user in the CLI. CLI assistance method 200 intercepts a command to a cloud platform that was entered into a command line interface to the cloud platform. CLI assistance method 200 records the command in a conversation history and passes the command to the cloud platform to execute. CLI assistance method 200 intercepts a response to the command that was returned from the cloud platform to the command line interface. CLI assistance method 200 records the response in the conversation history and passes the response to a generative AI model (such as a large language model). Passing the response to the generative AI model initiates generation of an enhanced response based at least in part on the response and context from the conversation history. CLI assistance method 200 receives the enhanced response from the generative AI model. And CLI assistance method 200 presents the enhanced response in the command line interface.

In one embodiment CLI assistance method 200 initiates at START block 205 in response to CLI assistance system 100 determining one or more of (1) CLI assistance system 100 has been instructed to generate enhanced responses in the CLI of a cloud platform; (2) a command to a cloud platform has been received in a CLI for which the CLI assistance system is active; (3) that an instruction to perform CLI assistance method 200 has been received; (4) a user or administrator has initiated CLI assistance method 200; (4) it is currently a time at which CLI assistance method 200 is scheduled to be run; or (5) CLI assistance method 200 should commence in response to satisfaction of some other condition. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of CLI assistance system 100 executes CLI assistance method 200. In one embodiment, at START block 205, CLI assistance method 200 (i) configures the computing system with system settings, software dependencies and libraries, and modules for the components of CLI assistance system 100; (ii) connects to external services, such as an API to cloud platform 130; and (iii) allocates and initializes resources used by CLI assistance method 200, such as processor, memory, storage, and network connections. Following initiation at START block 205, CLI assistance method 200 proceeds to block 210.

At block 210, CLI assistance method 200 intercepts, in a command line interface to a cloud platform, a command to the cloud platform. CLI method 200 captures a command that is entered into the command line interface before it is sent to the cloud platform. In one embodiment, CLI assistance method 200 monitors the CLI for input; detects when the user has entered a command; and stores the entered command. In one embodiment, monitoring the CLI for input may include implementing a listening mechanism within the CLI environment that continuously watches for user-entered commands. In one embodiment, detection of command submission identifies when the user presses an enter key following writing a string of text in the CLI. In one embodiment, storing the command includes intercepting the command string that is on its way to the back end (e.g., API) of the cloud platform, and then buffering or otherwise temporarily holding the command within the CLI environment, for example by assigning a command variable to have the value of the entered string. In one embodiment, the steps of block 210 are performed by command interceptor 110. At the conclusion of block 210, processing continues to block 215.

At block 215, CLI assistance method 200 records the command in a conversation history and passes the command to the cloud platform to execute. CLI assistance method 200 logs the command for future reference, then forwards the command to the cloud platform to run. In one embodiment, CLI assistance method 200 prepares the command for logging, accesses (or, on an initial command, creates) the conversation history data structure; adds the command to the conversation history; passes the command to the cloud platform; and waits for the response from the cloud platform.

In one embodiment, preparing the command for logging may include formatting or structuring the command string for inclusion in the conversation history, for example by adding a time stamp or labeling the command to distinguish it from other commands, responses, and/or enhanced responses in the conversation history, for example by prefixing the command by “user:”. In one embodiment, accessing the conversation history data structure includes: identifying the appropriate log file (or database) of the conversation history, such as a text file, JSON file, or other appropriate file format, checking whether the file exists already, opening the file for writing (if it exists) or creating the file for writing (if it does not exist). In one embodiment, adding the command to the conversation history appends the command to the end of the conversation history, thereby logging the command in sequence with other commands, responses, and enhanced responses. In one embodiment, passing the command to the cloud platform involves composing and sending a call to the API of cloud platform to cause the command to be processed by the cloud platform.

In one embodiment, the steps of block 215 are performed by command interceptor 110 and conversation history data structure 120. At the conclusion of block 215, processing continues to block 220.

In one embodiment, generally, context is maintained in the CLI assistance system by adding to the conversation history and maintaining the previous commands in a context window. The context window is a subset of the conversation history that is currently active or being considered when generating responses. In one embodiment, the context window covers the entire conversation history. In another embodiment, where the generative AI model is limited as to how much context can be processed at once, the CLI assistance system selects portions of the conversation history to focus on most recent and relevant parts of the conversation history. In one embodiment, appending to the conversation history is performed by commands which push the LLM to build a context as the conversation progresses, and to observe the context holistically (in view of the relevant conversation history) rather than treat the commands as standalone commands. This is maintained in the user's session history through the conversation history file that expands over the course of the session. The prompts instruct the generative AI to check the context and respond within it.

At block 220, CLI assistance method 200 intercepts a response to the command that was returned from the cloud platform to the command line interface. CLI assistance method 200 captures the response from the cloud platform before it is shown in the command line interface. In one embodiment, CLI assistance method 200 monitors output to the CLI; detects a transmission to the CLI from the cloud platform that carries the response; extracts the response, and stores the returned command. In one embodiment, monitoring output to the CLI may include implementing a listening mechanism within the CLI environment that continuously watches for incoming messages—in particular, responses to the previously-entered commands—from the API of the cloud platform. In one embodiment, detection of the response may include intercepting a data stream, API call, or other transmitted electronic message that carries the response back to the CLI. In one embodiment, extraction of the response includes parsing the detected electronic message to separate a string—i.e., the response—from the routing or other information of the detected electronic message. In one embodiment, storing the electronic message includes buffering or otherwise temporarily holding the response within the CLI environment, for example by assigning a response variable to have the value of the extracted string. In one embodiment, the steps of block 220 are performed by response interceptor 115. At the conclusion of block 220, processing continues to block 225.

At block 225, CLI assistance method 200 records the response in the conversation history and passes the response to a generative AI model to initiate generation of an enhanced response based at least in part on the response and context from the conversation history. CLI assistance method 200 saves the response from the cloud platform in the log, and then sends the response to the generative AI model to create an improved reply using the response and previous interactions. In one embodiment, CLI assistance method prepares the response for logging; accesses the conversation history data structure; adds the response to the conversation history; prepares the response for the generative AI model; sends the response and context to the generative AI model; and waits for the enhanced response from the generative AI model.

In one embodiment, preparation of the response for logging may include formatting or structuring the response string for inclusion in the conversation history, for example by adding a time stamp or labeling the response to distinguish it from other commands, responses, and/or enhanced responses in the conversation history, for example by prefixing the response by “cloud platform:”. In one embodiment, accessing the conversation history data structure includes identifying the appropriate log file (or database) of the conversation history, such as a text file, JSON file, or other appropriate file format, and opening the file for writing. In one embodiment, adding the response to the conversation history appends the response to the end of the conversation history, thereby logging the command in sequence (order of occurrence) with other commands, responses, and enhanced responses.

In one embodiment, preparing the response for the generative AI model readies the response for transmission to the generative AI model. For example, CLI assistance method 200 determines whether or not the response is an error message or a confirmation message and dynamically generates a prompt to the generative AI model. The prompts differ based on the determination of whether or not the response includes the term error (or other similar term), either (i) in the event of an error, requesting the generative AI to explain the error and propose potential solutions, or (ii) in the event of a confirmation, requesting the generative AI to explain the confirmation (and, in some configurations, to propose next steps based on the context. In one embodiment, CLI assistance method 200 retrieves a portion (or the entirety) of the conversation history as context, or information relevant to the prompt, for the generative AI. In one embodiment, the dynamically generated prompt and the context are formatted into an electronic message that the generative AI model can process, such as by being written as parameters into an API call to the generative AI model. In one embodiment, sending the response and context to the generative AI model is accomplished by transmitting the electronic message to an API of the generative AI model.

The CLI assistance method 200 then waits while the enhanced response is generated by the generative AI model. The generative AI model processes the provided prompt and context, using the prompt and context to generate an enhanced response. The generative AI model receives the context and the prompt. The generative AI model parses the input to understand the structure and content, identifying key elements like instructions, commands, responses, and any context in addition to the provided context from the conversation history. The generative AI model integrates the context into its understanding of the current input. For example, the generative AI model may apply an attention mechanism to focus on parts of the context that are relevant to the instructions of the prompt, analyze the sequence of commands and responses to maintain continuity and coherence in the generated response, track the progress of the user through a task to keep the generated response relevant to a current stage of the task, and otherwise leverage the conversation history. The generative AI model generates a context-aware enhanced response, synthesizing the combined context and the current input to generate an enhanced response that is informed by the entire conversation history. As requested by the prompt, the enhanced response explains the cloud platform's response, for example offering suggestions, correcting errors, or rephrasing the output of the cloud platform to be more user-friendly. The generative AI model then sends the enhanced response back to the waiting response interceptor.

In one embodiment, the steps of block 210 are performed by response interceptor 115 and conversation history data structure 120. At the conclusion of block 225, processing continues to block 230.

At block 230, CLI assistance method 200 receives the enhanced response from the generative AI. For example, CLI assistance method 200 gets output from the generative AI model (e.g., large language model) that enhances or improves the content of the response with user-friendly, plain language explanation, clarification, suggestions, or corrections. In one embodiment, the CLI assistance method 200 waits for the output by the generative AI; receives the enhanced response; checks for errors; and (optionally) logs the enhanced response.

In one embodiment, waiting for the output by the generative AI includes monitoring the API of the generative AI model for completion of the generation task. In one embodiment, receiving the enhanced response includes accepting an object provided by the API of the generative AI model that includes enhanced response (the enhanced response may for example be a JSON object or structured text) and then extracts the relevant content from the provided object as the enhanced response. In one embodiment, checking for errors identifies if problems occurred during the generation process, such as incomplete output, rate limiting, or API errors, and if so, either retry passing the response to a generative AI model (discussed at block 225 above) or provide a fallback response, such as “The CLI assistant is currently unavailable”. Optionally, the enhanced response may also be logged in the conversation history, for example by appending the enhanced response to the end of the conversation history. In one embodiment, the steps of block 230 are performed by response interceptor 115. At the conclusion of block 210, processing continues to block 235.

At block 235, CLI assistance method 200 presents the enhanced response in the command line interface. For example, CLI assistance method 200 causes the enhanced response to be shown in the command line interface. In one embodiment, the CLI assistance method 200 releases the enhanced response to the CLI, and causes the enhanced response to be displayed in the CLI. For example, the enhanced response is provided to an output stream of the CLI terminal (such as the standard output stream), for example by supplying the enhanced response as an argument to a print function. The terminal or shell of the CLI listens for and reads the enhanced response sent to the output stream, and then renders the enhanced response in-line in a display of the CLI.

In one embodiment, the steps of block 235 are performed by response interceptor 115 and CLI 105. At the conclusion of block 210, CLI assistance method 200 has generated an explanatory, user-friendly enhanced response and presented the enhanced response in-line, following previous commands and responses in the session, and in or near real time, rendering the CLI assistance immediate and timely. In this way, CLI assistance based on generative AI is made native to the CLI and provided automatically and transparently, without taking user steps in addition to writing CLI commands. Processing continues to END block 240, where CLI assistance method 200 concludes.

In one embodiment, at the conclusion of CLI assistance method 200, the method resets to block 210 to await entry of a further command into CLI 105. Upon entry of another command, CLI assistance method 200 is performed again, starting from block 210, for the newly-entered command. In one embodiment, CLI assistance method 200 may be repeated for a plurality of commands-such as for each command-over the course of a cloud CLI session. In one embodiment, the conversation history is updated for each round of command and response over the course of the session. In one embodiment, the conversation history is associated with one session (from user log-in to user log-out) of interaction with the cloud platform using the CLI. In one embodiment, the conversation history is associated with one user, and may span a plurality of sessions.

### —Further Features of Example CLI Assistance Method—

In one embodiment, CLI assistance method 200 dynamically generates prompts from the cloud platform response that are configured to cause the generative AI model to produce the enhanced response (as discussed at block 225 and elsewhere herein). For example, CLI assistance method 200 further includes dynamically generating a prompt to the generative AI model that includes the response, the conversation history and instructions configured to specify information to be included in the enhanced response, wherein the response is passed to the generative AI model using the prompt, accompanied by the conversation history.

In one embodiment, CLI assistance method 200 further improves the CLI by retrieval augmented generation (RAG) using information that is specific to CLI interaction with the cloud platform. The context provided by the conversation history may be used to match content of a manual for the CLI interface to the cloud platform, and then, based on the matched content in the manual, (i) add recommended actions (such as suggested corrections to an error or follow-up actions in a process) to the enhanced response, and/or (ii) provide additional contextual information (such as best practices or background information) related to the command to the enhanced response. Thus, in one embodiment, CLI assistance method 200 may further retrieve information that matches the conversation history from a manual for the command line interface to the cloud platform; and generate the enhanced response to include recommended actions based on the matched information. And, in one embodiment, CLI assistance method 200 may further retrieve information that matches the conversation history from a manual for the command line interface to the cloud platform; and generate the enhanced response to include contextual information based on the matched information.

In one embodiment, CLI assistance method 200 accesses the conversation history data structure to gather past commands, responses, and other interactions relevant to a pending prompt. Then CLI assistance method 200 searches content of the manual (or other documentation) to identify sections relevant to the pending prompt. The CLI assistance method 200 extract the sections of the manual that are most relevant based on the current context, focusing on areas that provide explanations, error corrections, or recommended follow-up actions. Based on the matched manual content, CLI assistance method 200 generates (using the generative AI model) recommended actions for the user such as corrections for errors, next steps in a process, or best practices or background relevant to the command or response.

In one embodiment, the CLI assistance method 200 further improves the CLI by analyzing an error response from the cloud platform and providing specific advice in the CLI for handling the particular error that has occurred. For example, CLI assistance method 200 detects that the response indicates an error; and then dynamically generates a prompt to the generative AI model (e.g., LLM) that includes the response and instructions. The instructions are configured to cause the large language model to include in the enhanced response (i) an explanation of the error and (ii) a corrective solution to the error. The response is passed to the large language model using the prompt.

In one embodiment, the CLI assistance method 200 further improves the CLI by allowing direct conversation through a cloud platform CLI with a generative AI model that is specifically configured to assist with tasks related to the cloud platform. The user is thereby enabled to ask the generative AI model, in-line in the CLI, for assistance, and to receive, in-line in the CLI, a generative response providing the requested assistance. For example, the user may ask how certain tasks are performed using the CLI, and be given an explanation of how to perform the tasks. In this way, the user can receive specific instruction on how to achieve a given task in the cloud platform using the CLI to the cloud platform without ever leaving the CLI to the cloud platform. In one embodiment, CLI assistance method 200 detects that a command is a prompt for conversing with the generative AI model, for example by detecting that a prefix designating the cloud platform is absent from the command, or that a prefix designating the generative AI model (e.g., “assistant”) is present at the beginning of the command. In one embodiment, CLI assistance method 200 detects that a command is a prompt for conversing with the generative AI model by detecting that the command is written with a syntax of a human language query, rather than with the syntax of a command to the cloud platform. CLI assistance method 200 intercepts the prompt and submits the prompt to the generative AI model and records the prompt in the conversation history. The prompt is not passed to the cloud platform. CLI assistance method 200 receives a response generated by the generative AI in response to the prompt and records the response in the conversation history. And, CLI assistance method 200 presents the enhanced response in the command line interface.

In one embodiment, the CLI assistance method 200 further improves the CLI by diverting the command from submission to the cloud platform and analyzing incomplete or malformed commands to suggest corrections to the command of the command prior to submission to the cloud platform. In one embodiment, CLI assistance method 200 detects that the command is incomplete (or malformed), and then dynamically generates a prompt to the large language model that includes the command and instructions. The instructions are configured to cause the large language model to generate (i) an explanation of why the command is incomplete and (ii) an example of a complete command. CLI assistance method 200 then submits the prompt to the large language model, and captures the generated explanation and complete command example. CLI assistance method 200 presents the explanation and the example generated by the large language model in the command line interface. CLI assistance method 200 then accept revisions to the command in the command line interface. The revisions correct the command before submission to the cloud platform.

In one embodiment of CLI assistance method 200 generates the enhanced response in real time. (Or, the enhanced response is generated in real time.) “Real time”, as used herein, refers to immediate or nearly immediate processing and response to events or data as they happen or occur. In real time operation, there is minimal delay between input, processing, and output, although occasional delays are tolerable without causing significant issues. For example, in real-time operation of the CLI assistance system, delays between user input and presentation of the enhanced response that are caused by AI generation of the enhanced response are on a scale that is acceptable to a human (for example, under 15 seconds), while excluding processing time taken by cloud platform to execute a command, thereby keeping generation of the enhanced response aligned with timing of the underlying response by the cloud platform.

In one embodiment, the generative AI model is a large language model. In one embodiment, the LLM is a Cohere LLM.

### —Example Data Flow for CLI Assistance—

FIG. 3 illustrates one embodiment of a CLI assistance data flow 300 associated with generative AI assistance that is integrated into a cloud CLI. Data flow 300 shows the flow of commands and responses among various components of a CLI assistance system. In one embodiment, the CLI assistance system includes on premises components 305 and cloud infrastructure components 310. In one embodiment, a command line interface 315 to cloud infrastructure 310 is configured to provide generative AI assistance, as shown and described herein. Cloud infrastructure 310 includes a cloud infrastructure API 320 that is configured with programming instructions and standards for accessing, managing, or otherwise controlling cloud services provided by the cloud infrastructure 310. Cloud infrastructure API 320 is configured to accept and execute text-based commands through the CLI 315 for controlling the cloud services, and provide text responses that describe the results of command execution. Cloud infrastructure 310 may also host a generative artificial intelligence 325 model, such as a Cohere AI or ChatGPT large language model.

In a first step 330, a client 335 (such as a device associated with a user, administrator, or client application) enters a command into the CLI 315. In one embodiment, the client 335 puts in the command through the CLI 315 that has been enhanced with generative AI assistance. The command is sent through the client 335 to the CLI 315.

In a second step 340, the CLI 315 passes the command to the cloud infrastructure API 320. The cloud infrastructure API 320 generates a response to the command (also referred to as command output). The command output includes the relevant data, or an error shared back to the CLI 315. In one embodiment, the CLI also passes the command to the generative AI 325 at sub-step 342. Passing the command to the generative AI 325 serves to maintain context surrounding the command output (responses).

In a third step 345, the cloud infrastructure API 320 returns the command output to the CLI 315. Cloud infrastructure API 320 has caused the commands to be executed by the cloud infrastructure 310, and has collected the response of the cloud infrastructure 310 to the execution of commands. The response of the cloud infrastructure 310 may be confirmation messages or error messages, and their associated information, which may be returned as command output of the cloud infrastructure API 320 in response to execution of the command. Cloud infrastructure API 320 passes the command output back to the CLI 315. The CLI 315 is configured to implement the generative AI assistance, and so intercepts the command output prior to display in the CLI 315.

Instead of simply displaying the command output, in a fourth step 350, the CLI 315 passes the command output to the generative AI 325. Here, the CLI 315 leverages the generative AI 325 to add cognitive context to the command output. CLI 315 forwards the command output to generative AI 325 for interpretation. Generative AI 325 processes the command output, adding additional information to the command output, and making the command output more human readable. In one embodiment, generative AI 325 can recommend actions in the event an error is generated (as may be indicated in the command output), and also describe how the command can be re-phrased and re-run to avoid that error. In a fifth step 355, the generative AI 325 returns a cognitively enhanced response to the CLI 315.

And, in a sixth step 360, the CLI 315 presents the cognitively enhanced response to the client 335. In this way, the CLI 315 shows augmented output. Client 335 receives the command output, along with the cognitive augmentation generated by the generative AI 325.

### —Context and Discussion of Generative AI-based CLI Assistance—

In one embodiment, the CLI assistance system leverages a generative AI large language model (LLM), to enhance comprehension of command line interface (CLI) output. For example, the CLI assistance system is configured to enhance both regular responses and error messages in the CLI. The CLI assistance system enables users to receive clear and comprehensive explanations for their commands and the results of their commands, thereby streamlining workflows and promoting efficient troubleshooting. The innovative solution caters to both novice and experienced users, improving their understanding of CLI operations and optimizing their interactions with the cloud platforms.

The CLI assistance system may employ a variety of generative AI LLMs to enhance the CLI command output. In general, the generative AI LLM operates as an AI-powered chatbot that accepts CLI commands and cloud infrastructure responses in prompts, and generates text to enhance the cloud infrastructure responses to the CLI. In one embodiment, the CLI assistance system uses a generative AI LLM provided by Cohere. In another embodiment, the CLI assistance system uses a generative AI LLM provided by OpenAI (ChatGPT). Other generative AI LLMs may also be acceptable. In one embodiment, the CLI assistance system accesses the model through a chat endpoint of an API for the LLM.

The CLI assistance system integrates readily with CLIs to cloud services. For example, the CLI assistance system may be used with CLIs to a variety of cloud services such as Oracle Cloud Infrastructure (OCI), Amazon Web Services (AWS), Google Cloud Platform (GCP), and Microsoft Azure.

In one embodiment, the CLI assistance system integrates a specialized script (such as a Python script) with an existing cloud CLI. The specialized script acts as an interceptor to capture interactions with the cloud, and pass the interactions to a generative AI. For example, the script reads the user input into the cloud CLI, and through a specialized, dynamically-generated prompt, passes the input to the generative AI engine to maintain context of the tasks of the user in the generative AI. And, the script then reads the output of the cloud in the CLI—which the cloud often returns as success/failure codes—and through another specialized, dynamically-generated prompt, passes the input to the generative AI engine for re-interpretation into human language by the generative AI. The script then presents the reinterpreted or otherwise enhanced output in the CLI. The script thus uniquely sits in the middle between the cloud CLI and the user, augmenting the CLI using generative AI. The generative AI is thus natively integrated into the CLI interface itself for automatic delivery of comprehensive explanation in-line in the CLI.

In one embodiment, the CLI assistance system addresses the challenge of understanding and interpreting output, including error messages, that are generated by the CLI to the cloud infrastructure. The CLI assistance system enhances the comprehension of cloud CLI output by leveraging an AI to provide detailed explanations, thus addressing the issues of ambiguity and complexity in interpreting cloud CLI responses. And, in one embodiment, the CLI assistance system incorporates the cognitive and context maintenance abilities of modern LLMs that are absent from even the most human-readable, user-friendly CLIs.

In one embodiment, the CLI assistance system described herein utilizes an API to a generative AI model (such as Cohere, ChatGPT, or other LLM) to translate and provide detailed explanations for the cloud CLI error messages and other responses, aiding users in troubleshooting and resolving issues effectively.

In one embodiment, at a high level, the CLI assistance system includes various components for integration of generative AI interaction with the CLI for the cloud. The CLI assistance system integrates with the cloud CLI to capture error messages and input commands. The CLI assistance system interfaces with an LLM API (such as Cohere API), thereby interacting with an AI-powered chatbot capable of understanding and responding to natural language prompts. In one embodiment, a script (such as a Python script) facilitates the interaction between CLI, LLM API, and the user, providing for the translation and explanation of cloud CLI error messages.

In one embodiment, at a high level, a CLI assistance method operates in a workflow that integrates explanatory content by generative AI into the CLI output. At user input, users encountering cloud CLI error messages may input the error message and the respective command, or the CLI assistance method may automatically capture the error message and respective command. During cloud CLI execution, the CLI assistance system executes the provided cloud CLI command and captures the output, including error messages. The CLI assistance system then generates prompts to the LLM. For example, a Python script generates a prompt for the LLM API (e.g., Cohere) using the cloud CLI output. If an error is detected, a specific prompt for error explanation is constructed. The CLI assistance system submits the prompt to the LLM API for processing. In response, the LLM generates a clear and concise explanation of the error message. The CLI assistance system then displays the explanatory text content generated by the LLM in the CLI itself. The generated explanation is presented to the user, enhancing their understanding of the encountered error and guiding appropriate actions for resolution.

### —Example Script Operation for CLI Assistance Method—

In one embodiment, to perform the CLI assistance method, a CLI assistance system executes one or more scripts (or other modules) that perform the following functions.

The CLI assistance method first performs imports that bring in specific modules and/or libraries. The CLI assistance method imports a client library for the platform of the generative AI model (such as the Cohere or OpenAI platforms). The client library is used to interact with the generative AI model through an API, allowing the CLI assistance system to generate text (or perform other natural language processing tasks). The CLI assistance method imports a module that provides access to variables used or maintained by the script (e.g., Python) interpreter, and to functions that interact with the interpreter. In particular, the CLI assistance method imports a module that can be used to used to read command-line arguments (e.g., user-input commands). The CLI assistance method imports a function that runs a command in the CLI shell and returns the output as a string. The CLI assistance method imports a module for using operating system-dependent functionality like navigating, reading from, or writing to the file system. In particular, the CLI assistance method imports a module that can be used to determine if a particular file path exists. The CLI assistance method imports a module used to parse JSON (JavaScript Object Notation) strings and to generate JSON strings from data (e.g., Python) objects.

The CLI assistance method initializes variables such as the API key for the platform of the generative AI model. The CLI assistance method then creates an instance of a client of the platform of the generative AI model, using the API key to authenticate the instance. The instance of the client may be maintained during the cloud CLI session, and terminated at the close of the CLI session.

The CLI assistance method defines a function to capture responses to the CLI from the cloud platform that are generated by the CLI in response to entered commands. In one embodiment, the function for response capture takes a command that was entered in the CLI as an argument, embeds it in a string literal, runs the command in the shell (e.g., executing the command through the API), and returns the output response (either standard output or error output) as a string.

The CLI assistance method defines a function to generate a prompt based on the response. In one embodiment, the function for prompt generation accepts the output response, and then parses the output response to determine if the strong “Error” is included in the output response. Where the string “Error” is included in the output, the function returns a dynamically generated prompt that combines (i) instructions to a generative AI model to explain the cloud platform CLI error and how to solve it, and (ii) the output response. For example, the dynamically generated prompt for responding to the error may be “Explain the following [insert cloud platform name] CLI error in simple [insert language of user] and how to solve it: [insert output response that includes the error]”. Where the string “Error” is NOT included in the output, the function returns a dynamically generated prompt that combines (i) instructions to a generative AI model to explain cloud platform CLI response, and (ii) the output response. For example, the dynamically generated prompt for responding to the error may be “Explain the following [insert cloud platform name] CLI output: [insert output response that includes the error]”. The dynamically generated prompts are returned as strings.

The CLI assistance method defines a function to send the prompt to the generative AI model and get an enhanced response. In one embodiment, the function for prompt transmission and enhanced response collection accepts the dynamically generated prompt and context from the conversation history as arguments. The function to send the prompt augments the dynamically generated prompt with further instructions to consider the context. For example, the function to send the prompt may generate a full prompt that includes context as follows: “You are an assistant helping with [insert cloud platform here] CLI operations. Keep the context of [insert cloud platform here] CLI operations in mind. [Insert conversation history here]. [Insert dynamically generated prompt here].” The function for prompt transmission then instructs the generative AI model (through the API for the model) to generate a response to the full prompt to be the enhanced response. The instruction may further specify: (i) a particular generative AI model; (ii) the maximum size of the response (e.g., by placing a maximum on tokens: between 400 and 600 tokens, such as approximately 500 tokens, has been found acceptable in experimentation); (iii) a temperature value to control the randomness of the model (here, a temperature of between 0.3 and 0.7, such as 0.5 has been found to be acceptable in experimentation); (iv) a k value that limits the top number of most probable tokens at each step of generation (here, a restrictive k value of 2 or less, for example k=0, is acceptable); and (v) any stop sequences to tell the model to stop generation (in general, no stop sequences are applicable here). The function for prompt transmission and enhanced response collection captures the enhanced response produced by the generative AI model through the API and returns the enhanced response as a string.

The CLI assistance method defines a function to load a conversation history from a file. In one embodiment, the function for conversation history loading accepts a file path to the conversation history file as an argument. The function for conversation history loading checks if the file path that is provided for the conversation history is valid (i.e., exists, as determined for example by using the module for using operating system-dependent functionality imported above), the function then opens the conversation history file at the file path, reads the conversation history, and returns the conversation history as a JSON string.

The CLI assistance method defines a function to save a conversation history to a file. In one embodiment, the function for conversation history saving accepts a file path to a destination conversation history file and content to be added to the conversation history file. The function for conversation history saving opens the file path to the for writing. The function then writes the conversation history to the destination conversation history file, for example by serializing the conversation history and dumping it to file object as JSON data.

The CLI assistance method defines a main function to perform the logic of the CLI assistance method. The main function initializes the conversation history file that holds the conversation history. The main function loads the conversation history using the function to load a conversation history, and passing the conversation history file to the function as an argument. The main function gets the user input (command) from the command line argument. The main function checks to determine whether the user input starts with a prefix that identifies the cloud platform (for example, “oci” for commands to Oracle Cloud Infrastructure). Here, the main function takes one of two branching paths based on whether or not the command includes the proper prefix. In one embodiment, a more in-depth assessment of whether or not the command is complete, or whether or not the command is malformed may be performed in pace of the simple check for the prefix.

Where the prefix is included (or where the command is otherwise complete or not malformed), the main function proceeds though a process to execute the command and display an AI-enhanced response to the command that provides explanation of the response by the cloud platform. The main function removes or ignores the characters of the prefix to get the actual command, executes the command on the cloud platform through the cloud API using the function to capture responses to the CLI by the cloud platform described above, and captures the output response to the command. The main function adds to the conversation history both (i) the user-input command and (ii) the response by the cloud platform. For example, the system appends the text “User: oci”+command to the conversation history, followed by the text “System:”+response to the conversation history. The main function also generates a prompt to the generative AI model based on the response from the cloud platform, for example as described in the function for prompt generation above. The main function then sends the prompt to the generative AI model along with the conversation history, and captures the enhanced response, for example by passing the prompt and the conversation history as arguments the function discussed above for sending the prompt to the generative AI model and getting an enhanced response. The main function then prints the response from the cloud platform and the enhanced response to the CLI. When printing enhanced responses from the generative AI, the enhanced response may be preceded by printed text that indicates that it is provided by the CLI assistant, such as “Assistant Explanation:” The main function further adds the enhanced response to the conversation history. And, the main function adds the enhanced response to the conversation history, for example, by appending the text “Assistant:”+enhanced response to the conversation history

Where the prefix is not included (or where the command is otherwise incomplete or malformed), the main function proceeds though a process to obtain and display an AI-enhanced response to the command that provides corrective guidance for correction of the command. The main function sends the user input directly to the generative AI model for a response, while maintaining the context. For example, the main function updates the context by appending the user-input command (as discussed above) to the conversation history. And, the main function then sends the command to the generative AI model along with the conversation history (for example by passing the prompt and the conversation history as arguments the function discussed above for sending the prompt to the generative AI model and getting an enhanced response), and then captures the enhanced response from the generative AI model. The main function then prints the enhanced response to the CLI. And, the main function adds the enhanced response to the conversation history, for example, by appending the text “Assistant:”+enhanced response to the conversation history.

The main function then saves the conversation history, for example by passing the history file path and the updated conversation history as arguments to the function discussed above for conversation history saving.

The main function may repeat in a loop, iterating once in response to an individual command entered into the CLI. In this way, AI-powered CLI assistance is made available-natively, and in-line in the CLI—as the user interacts with the cloud platform through the CLI.

### Various Advantages and Improvements

In one embodiment, at a high level, the CLI assistance system introduces a number of novel features that significantly enhance interaction with Cloud Infrastructure through the command line, as highlighted below:

Cognitive Command Response Enhancement. In one embodiment, CLI assistance system employs advanced cognitive computing techniques to transform standard OCI CLI responses into enriched, context-aware, and human-friendly narratives, aiding users in comprehending complex cloud infrastructure feedback.

Intelligent Error Handling and Guidance. Unlike traditional CLI tools that output cryptic error messages, in one embodiment, the CLI assistance system interprets errors cognitively and offers clear, actionable recommendations and step-by-step guidance to resolve issues, thereby reducing troubleshooting time and improving user experience.

Enhanced Human Readability. In one embodiment, the CLI assistance system automatically adds explanatory notes, disambiguates technical jargon, and provides summaries for technical outputs, making the CLI more accessible to users of varying expertise levels. The enhanced content significantly lowers the knowledge bar for use of a CLI to manage a cloud system.

Augmented Command Outputs. In one embodiment, by integrating additional information directly into the command outputs, the CLI assistance system provides a richer, more informative interface, allowing users to gain a comprehensive understanding of their cloud environment with less effort.

In one embodiment, the CLI assistance system configures the LLM to use retrieval augmented generation (RAG). With RAG, the generative AI scans existing cloud CLI manuals, matching manual content with the user's context through his previous commands. Based on the matched content, the error is interpreted within the user's context and recommended actions are provided.

Comprehensive Interpretation. In one embodiment, the CLI assistance system provides a holistic understanding of Command Line Interface (CLI) output that is specific to the particular cloud system accessed by the CLI. The holistic understanding encompasses confirmation responses and error message responses. When an output message indicates, for instance, that an object storage cannot be created due to a missing policy, this is typically listed as an error code. The generative AI engine then maps this error code to a human language explanation along with a recommended action to resolve it. In case of an output message indicating a success, the generative AI engine indicates the success and digest the output of the command to make it more human-readable. This will allow for an easier interaction with the cloud system through the command line and lower the threshold of knowledge needed to interact with the cloud through the command line.

An example of the comprehensive interpretation of command line content provided by the CLI assistance system follows. In this and other examples presented herein, the cloud system is Oracle Cloud Infrastructure (OCI), and the commands and responses are consistent with use of the CLI assistance system with a CLI to OCI.

### Command Input:

oci os bucket create—name myBucket

### OCI Response:

Error: AuthorizationFailed. User not authorized to perform action ‘CreateBucket’

### Contextualized Output:

Error: AuthorizationFailed. You are not authorized to create a bucket.
Reason: The current user does not have the necessary permissions (‘CreateBucket’) for this action.
Suggested Action: Verify your user permissions and ensure you have the ‘CreateBucket’ policy attached to your user or group. If you need assistance with modifying policies, refer to the Oracle Cloud Infrastructure documentation on policy management or contact your administrator.

LLM Integration. In one embodiment, the CLI assistance system provides integration of an AI-powered natural language processing tool to translate and explain the entire spectrum of CLI output, enhancing user comprehension. The CLI assistance system employs an API to an LLM (such as Cohere API or ChatGPT API) to integrate with and access the language processing tools of the LLM.

Universal Output Handling. In an improvement, in one embodiment the CLI assistance system overcomes the challenge of interpreting all types of output generated by the cloud CLI, ensuring a comprehensive solution for users.

Dynamic Prompt Generation. In one embodiment of the CLI assistance system, the script dynamically generates prompts for the LLM API based on the cloud CLI output, facilitating accurate and relevant responses.

Seamless User Experience. In an improvement, in one embodiment the CLI assistance system simplifies the user experience by seamlessly integrating the AI-powered explanation process within the existing cloud CLI workflow, requiring minimal user intervention.

Efficient Troubleshooting. In an improvement, in one embodiment the CLI assistance system facilitates efficient troubleshooting by offering clear, concise, and actionable explanations for both successful output and encountered errors, aiding in prompt issue resolution.

Adaptive AI Interaction. In an improvement, in one embodiment the CLI assistance system utilizes AI to adapt and respond intelligently to various OCI-CLI command outputs, ensuring relevant and accurate explanations for a wide range of user interactions.

Enhanced Error Understanding. In one embodiment, the CLI assistance system provides enhanced error understanding in-line in the CLI. The system provides detailed explanations for OCI-CLI error messages, aiding users in troubleshooting and resolving issues efficiently.

Time and Frustration Savings. In one embodiment, the CLI assistance system enables users to quickly understand error causes and take appropriate actions, reducing time and frustration associated with error resolution.

Ease of Integration. In one embodiment, the CLI assistance system can be seamlessly integrated into existing cloud CLI workflows, requiring minimal modifications.

### Example Scenario: Deploying a New Compute Instance

An example scenario showing operation of one embodiment of the CLI assistance system follows. Here, the scenario is deploying a new compute instance with specific requirements. In this example, the commands and enhanced responses within the CLI are shown.

As with the other examples herein, this example scenario is a non-limiting example interaction with Oracle Cloud Infrastructure (OCI) employing an embodiment of the CLI Assistance system. Accordingly, the example commands are OCI commands. Other cloud infrastructure systems such as Azure and Amazon Web Services may also employ the CLI assistance system, with commands and narrative changed to be consistent with the target cloud infrastructure system.

Bob, a systems administrator, is tasked with deploying a new compute instance on Oracle Cloud Infrastructure (OCI). While Bob is familiar with general cloud concepts, he's still getting accustomed to the nuances of OCI CLI commands.

Command Input: Bob starts by typing the basic command to create a new compute instance:
oci compute instance launch—image-id ocid1.image.oc1 . . . exampleuniqueID—shape VM.Standard2.1
   Bob remembers to specify the image ID and shape but is uncertain about the network and storage configurations

Cognitive Enhancement: The CLI assistance system detects the incomplete command and intervenes, suggesting Bob to specify a subnet for the instance to ensure it is launched within the correct virtual cloud network (VCN). The CLI assistance system also prompts him to define the availability domain. The CLI assistance system provides an enhanced command:
oci compute instance launch—image-id ocid1.image.oc1 . . . exampleuniqueID—shape VM.Standard2.1—subnet-id ocid1.subnet.oca . . . exampleuniqueID—availability-domain “Uocm: PHX-AD-1”
   The enhanced command is an example of a complete command, and includes an example subnet ID that Bob may replace with his own desired subnet ID.

Error Interpretation and Recommendation: Bob enters the command with the options provided. However, he accidentally uses an incorrect image ID. The command fails, and the CLI assistance system intercepts the error:

```
ServiceError:
{
  “code”: “InvalidParameter”,
  “message”: “The image ID ‘ocid1.image.oc1..exampleuniqueID’ does
  not exist.”
}
```

The CLI assistance system parses this error and guides Bob to find the correct image ID by providing a command to list available images:
oci compute image list—compartment-id ocid1.compartment.oc1 . . . exampleuniqueID

Augmented Output with Contextual Information: After successfully launching the instance, in one embodiment, the CLI assistance system need not stop at the standard success message. Instead, the CLI assistance system augments the output with a summary of the performance capabilities of the instance, cost estimates, and a reminder for Bob to check the boot volume size and to configure the security list for the instance.

Follow-up Actions: The CLI assistance system then suggests next steps, such as attaching a block storage volume or setting up cloud network rules, complete with the necessary commands and considerations for each step:
oci compute volume attach—instance-id ocid1.instance.oc1 . . . exampleuniqueID—type paravirtualized—volume-id ocid1.volume.oc1 . . . exampleuniqueID
oci network security-list create—von-id ocid1.vcn.oc1 . . . exampleuniqueID—egress-security-rules . . . .

### —Example Conversation Flow: Deploying a New Compute Instance—

Another example scenario showing operation of one embodiment of the CLI assistance system follows. As above, the scenario is deploying a new compute instance with specific requirements. In this example, the conversation flow within the CLI is shown.

Bob enters a command to launch a new compute instance:
oci compute instance launch—image-id ocid1.image.oc1 . . . exampleuniqueID—shape VM.Standard2.1

Copilot responds with guidance:
It looks like you're trying to launch a new instance. To ensure your instance is properly networked, you'll need to specify a subnet ID. Also, don't forget to assign it to an availability domain for redundancy. Here's the modified command with placeholders for subnet ID and availability domain:
oci compute instance launch—image-id ocid1.image.oc1 . . . exampleuniqueID—shape VM.Standard2.1—subnet-id<your-subnet-id>—availability-domain<your-availability-domain>
Replace <your-subnet-id> and <your-availability-domain> with your actual subnet ID and availability domain.

Bob enters the command with an incorrect image ID:
oci compute instance launch—image-id ocid1.image.oc1 . . . wrongID—shape VM.Standard2.1—subnet-id ocid1.subnet.oca . . . exampleuniqueID—availability-domain “Uocm: PHX-AD-1”

Copilot provides an error message and corrective action:
I noticed there's an issue with the image ID you provided. The image ID ‘ocid1.image.oc1 . . . wrongID’ does not exist. Let's find the correct image. You can list all available images in your compartment with the following command:
oci compute image list-compartment-id<your-compartment-id>
Make sure to replace <your-compartment-id> with the correct compartment ID where your resources are allocated.

Bob finds the correct image and re-enters the command:
oci compute instance launch—image-id ocid1.image.oc1 . . . correctID—shape VM.Standard2.1—subnet-id ocid1.subnet.oca . . . exampleuniqueID—availability-domain “Uocm: PHX-AD-1”

Copilot confirms success and offers further guidance:
Great, your instance is now being launched! Based on the instance type and configuration, you can expect the performance to be suitable for general purpose workloads. The estimated cost for this instance type is approximately $0.10 per hour. Please verify that this is within your budget.

As a next step, you might want to:
Check the boot volume size to ensure it meets your storage needs.
Configure the security list for your VCN to control traffic to and from the instance.
   Would you like assistance with these steps?

Bob asks for help with block storage and security rules:
Yes, please help me with setting up the block storage and security rules.

Copilot provides detailed instructions:
Certainly! To attach a block storage volume, use the following command, ensuring you replace <your-instance-id> and <your-volume-id> with the appropriate IDs:
oci compute volume attach—instance-id<your-instance-id>—type paravirtualized-volume-id<your-volume-id>
And to create a security list for your VCN, here's the command template:
oci network security-list create—von-id<your-von-id>—egress-security-rules <your-rules-json>
Replace <your-von-id> and <your-rules-json> with your VCN ID and a JSON string defining your egress rules. If you need a sample JSON or guidance on rules, just let me know.

### —Cloud or Enterprise Embodiments—

In one embodiment, the present system (such as CLI assistance system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, CLI assistance system 100 is a centralized server-side application that provides at least the functions disclosed herein and that is accessed by many users by way of computing devices/terminals communicating with the computers of CLI assistance system 100 (functioning as one or more servers) over a computer network. In one embodiment CLI assistance system 100 may be implemented by a server or other computing device configured with hardware and software to implement the functions and features described herein.

In one embodiment, the components of CLI assistance system 100 may be implemented as sets of one or more software modules executed by one or more computing devices specially configured for such execution. In one embodiment, the components of CLI assistance system 100 are implemented on one or more hardware computing devices or hosts interconnected by a data network. For example, the components of CLI assistance system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of CLI assistance system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of CLI assistance system 100 may (i) generate or compose an electronic message or signal to issue a command or request to another component, (ii) transmit the message or signal to other components of CLI assistance system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by CLI assistance system 100, for example through a web interface server. In one embodiment, the remote computing system may send requests to and receive responses from CLI assistance system 100. In one example, access to information or applications may be effected through use of a web browser on a personal computer or mobile device. In one example, communications exchanged with CLI assistance system 100 may take the form of remote representational state transfer (REST) requests using JavaScript object notation (JSON) as the data interchange format for example, or simple object access protocol (SOAP) requests to and from XML servers. The REST or SOAP requests may include API calls to components of CLI assistance system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

### —Computing Device Embodiment—

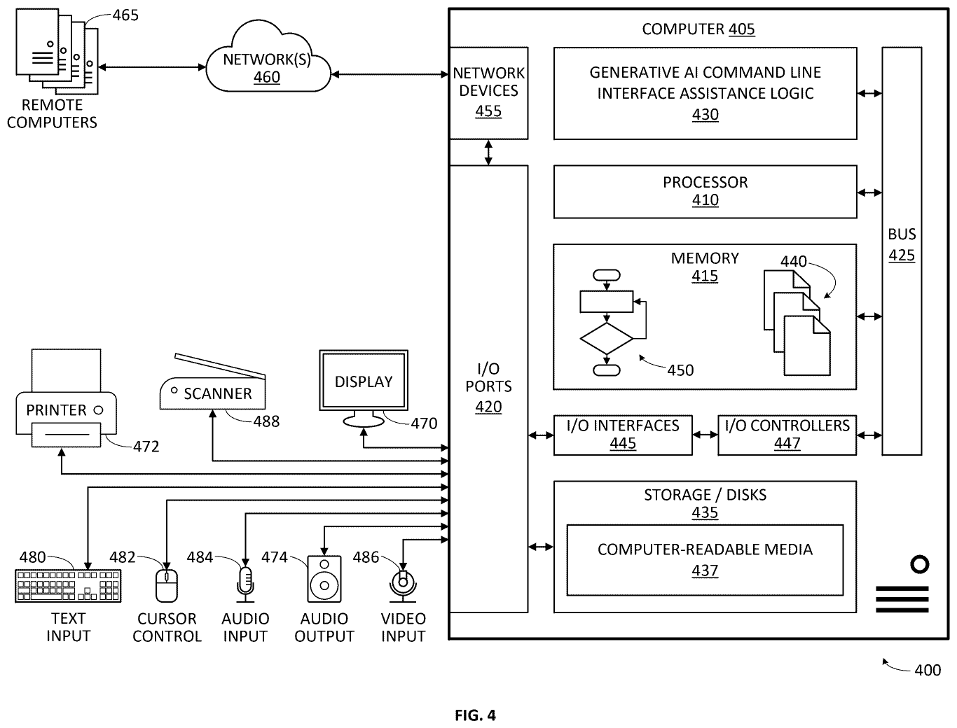

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include generative AI command line assistance logic 430 configured to facilitate generative AI assistance that is integrated into a command line interface to a cloud platform, similar to logic, systems, and methods shown and described above with reference to FIGS. 1, 2, and 3.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate generative AI assistance that is integrated into a command line interface to a cloud platform. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks with which the computer 405 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
intercept, in a command line interface to a cloud platform, a command to the cloud platform;
record the command in a conversation history and pass the command to the cloud platform to execute;
intercept a response to the command that was returned from the cloud platform to the command line interface;
record the response in the conversation history and pass the response to a generative AI model to initiate generation of an enhanced response based at least in part on the response and context from the conversation history;
receive the enhanced response from the generative AI model; and
present the enhanced response in the command line interface.

2. The one or more non-transitory computer-readable media of claim 1, further comprising computer-executable instructions that when executed by at least the processor cause the computing system to dynamically generate a prompt to the generative AI model that includes the response and instructions configured to specify information to be included in the enhanced response, wherein the response is passed to the generative AI model using the prompt, accompanied by the conversation history.

3. The one or more non-transitory computer-readable media of claim 1, further comprising computer-executable instructions that when executed by at least the processor cause the computing system to:
retrieve information that matches the conversation history from a manual for the command line interface to the cloud platform; and
generate the enhanced response to include recommended actions based on the information that matches the conversation history.

4. The one or more non-transitory computer-readable media of claim 1, further comprising computer-executable instructions that when executed by at least the processor cause the computing system to:
retrieve information that matches the conversation history from a manual for the command line interface to the cloud platform; and
generate the enhanced response to include additional contextual information based on the information that matches the conversation history.

5. The one or more non-transitory computer-readable media of claim 1, further comprising computer-executable instructions that when executed by at least the processor cause the computing system to:
detect that the response indicates an error;
dynamically generate a prompt to the generative AI model that includes the response and instructions configured to cause the generative AI model to include in the enhanced response (i) an explanation of the error and (ii) a corrective solution to the error, wherein the response is passed to the generative AI model using the prompt.

6. The one or more non-transitory computer-readable media of claim 1, further comprising computer-executable instructions that when executed by at least the processor cause the computing system to, prior to passing the command to the cloud platform to execute:
detect that the command is incomplete;
dynamically generate a prompt to the generative AI model that includes the command and instructions configured to cause the generative AI model to generate (i) an explanation of why the command is incomplete and (ii) an example of a complete command;
submit the prompt to the generative AI model;
present the explanation and the example generated by the generative AI model in the command line interface; and
accept revisions to the command in the command line interface.

7. The one or more non-transitory computer-readable media of claim 1, wherein the enhanced response is generated in real time.

8. A computing system, comprising:
a processor;
a memory connected to the processor;
one or more non-transitory computer-readable media that include stored thereon computer-executable instructions that when executed by at least the processor of the computing system cause the computing system to:
intercept, in a command line interface to a cloud platform, a command to the cloud platform;
record the command in a conversation history and pass the command to the cloud platform to execute;
intercept a response to the command that was returned from the cloud platform to the command line interface;
record the response in the conversation history and pass the response to a generative AI model to initiate generation of an enhanced response based at least in part on the response and context from the conversation history;
receive the enhanced response from the generative AI model; and
present the enhanced response in the command line interface.

9. The computing system of claim 8, wherein the computer-executable instructions, when executed by at least the processor, further cause the computing system to dynamically generate a prompt to the generative AI model that includes the response and instructions configured to specify information to be included in the enhanced response, wherein the response is passed to the generative AI model using the prompt, accompanied by the conversation history.

10. The computing system of claim 8, wherein the computer-executable instructions, when executed by at least the processor, further cause the computing system to:
retrieve information that matches the conversation history from a manual for the command line interface to the cloud platform; and
generate the enhanced response to include recommended actions based on the information that matches the conversation history.

11. The computing system of claim 8, wherein the computer-executable instructions, when executed by at least the processor, further cause the computing system to:
detect that a second command is a prompt for conversing with the generative AI model;
intercept the prompt and submit the prompt to the generative AI model and record the prompt in the conversation history, wherein the prompt is not passed to the cloud platform;
receive a second response generated by the generative AI model in response to the prompt and record the second response in the conversation history; and
present the enhanced response in the command line interface.

12. The computing system of claim 8, wherein the computer-executable instructions, when executed by at least the processor, further cause the computing system to:
detect that the response indicates an error;
dynamically generate a prompt to the generative AI model that includes the response and instructions configured to cause the generative AI model to include in the enhanced response (i) an explanation of the error and (ii) a corrective solution to the error, wherein the response is passed to the generative AI model using the prompt.

13. The computing system of claim 8, wherein the computer-executable instructions, when executed by at least the processor, further cause the computing system to, prior to passing the command to the cloud platform to execute:
detect that the command is incomplete;
dynamically generate a prompt to the generative AI model that includes the command and instructions configured to cause the generative AI model to generate (i) an explanation of why the command is incomplete and (ii) an example of a complete command;
submit the prompt to the generative AI model;
present the explanation and the example generated by the generative AI model in the command line interface; and
accept revisions to the command in the command line interface.

14. The computing system of claim 8, wherein the computing system generates the enhanced response in real time.

15. A computer-implemented method, comprising:
intercepting, in a command line interface to a cloud platform, a command to the cloud platform;
recording the command in a conversation history and passing the command to the cloud platform to execute;
intercepting a response to the command that was returned from the cloud platform to the command line interface;
recording the response in the conversation history and passing the response to a large language model to initiate generation of an enhanced response based at least in part on the response and context from the conversation history;
receiving the enhanced response from the large language model; and
presenting the enhanced response in the command line interface.

16. The computer-implemented method of claim 15, further comprising dynamically generating a prompt to the large language model that includes the response and instructions configured to specify information to be included in the enhanced response, wherein the response is passed to the large language model using the prompt, accompanied by the conversation history.

17. The computer-implemented method of claim 15, further comprising:
retrieving information that matches the conversation history from a manual for the command line interface to the cloud platform; and
generating the enhanced response to include recommended actions based on the information that matches the conversation history.

18. The computer-implemented method of claim 15, further comprising:
retrieving information that matches the conversation history from a manual for the command line interface to the cloud platform; and
generating the enhanced response to include contextual information based on the information that matches the conversation history.

19. The computer-implemented method of claim 15, further comprising:
detecting that the response indicates an error;
dynamically generating a prompt to the large language model that includes the response and instructions configured to cause the large language model to include in the enhanced response (i) an explanation of the error and (ii) a corrective solution to the error, wherein the response is passed to the large language model using the prompt.

20. The computer-implemented method of claim 15, further comprising, prior to passing the command to the cloud platform to execute:
detecting that the command is incomplete;
dynamically generating a prompt to the large language model that includes the command and instructions configured to cause the large language model to generate (i) an explanation of why the command is incomplete and (ii) an example of a complete command;
submitting the prompt to the large language model;
presenting the explanation and the example generated by the large language model in the command line interface; and
accepting revisions to the command in the command line interface.
